(19) United States
(12) Patent Application Publication
(10) Pub. No.: US 2024/0387956 A1
(43) Pub. Date: Nov. 21, 2024

(54) LITHIUM ION BATTERY

(71) Applicant: Thomas Gerhard Wilhelm Damitz, Qingdao (CN)

(72) Inventor: Thomas Gerhard Wilhelm Damitz, Qingdao (CN)

(21) Appl. No.: 18/576,612

(22) PCT Filed: Jul. 4, 2022
(86) PCT No.: PCT/CN2022/103628

§ 371 Date: Jan. 4, 2024

(30) Foreign Application Priority Data
Jul. 5, 2021 (CN) 202121510900.2

(51) Int. Cl. H01M 50/533; H01M 10/0525; H01M 10/058; H01M 50/534; H01M 50/552; H01M 50/562

(52) U.S. Cl. CPC H01M 50/533; H01M 10/0525; H01M 10/058; H01M 50/534; H01M 50/552; H01M 50/562

(57) ABSTRACT

The present invention provides a lithium ion battery. The lithium ion battery includes: a positive active material; a negative active material disposed opposite to the positive active material; a separator and an electrolyte disposed between the positive active material and the negative active material; a positive electrode tab in electrical contact with the positive active material and a negative electrode tab in electrical contact with the negative active material; and a case encapsulating the positive active material, the negative active material, the separator and the electrolyte; wherein a surface of the positive electrode tab and/or a surface of the negative electrode tab are provided with a plurality of recess structures.

### RELATED APPLICATIONS

The present application claims the benefit of Chinese Patent Application No. 202121510900.2, filed on Jul. 5, 2021, the entire disclosures of which are incorporated herein by reference.

### TECHNICAL FIELD

The present invention relates to the field of battery, and in particular, to a lithium ion battery and a manufacturing method thereof.

### BACKGROUND

Rechargeable lithium ion batteries (i.e., secondary lithium ion batteries) generally include one or more electrochemical cells having a negative electrode, a positive electrode, and an electrolyte for conducting lithium ions between the negative and positive electrodes. A porous separator wetted with a liquid electrolyte solution may be sandwiched between the electrodes to physically separate and electrically insulate the electrodes from each other while permitting free ion flow. Each of the negative and positive electrodes is typically carried on or connected to a metallic current collector. The current collectors may be connected to each other by an interruptible external circuit through which electrons can pass from one electrode to the other while lithium ions migrate in the opposite direction through the electrochemical cell during charging and discharging of the battery.

During discharging, the negative electrode contains a relatively high concentration of intercalated lithium, which is oxidized into lithium ions and electrons. The lithium ions travel from the negative electrode (cathode) to the positive electrode (anode), for example, through the ionically conductive electrolyte solution contained within the pores of the interposed porous polymeric separator. At the same time, the electrons pass through the external circuit from the negative electrode to the positive electrode. The lithium ions are assimilated into the positive active material by an electrochemical reduction reaction. The battery may be recharged after a partial or full discharge of its available capacity by an external power source, which reverses the electrochemical reactions that transpired during discharging.

During re-charge, intercalated lithium in the positive electrode is oxidized into lithium ions and electrons. The lithium ions travel from the positive electrode to the negative electrode through the porous separator via the electrolyte, and the electrons pass through the external circuit to the negative electrode. The lithium cations are reduced to elemental lithium at the negative electrode and stored in the negative active material for reuse.

### SUMMARY

The invention provides a lithium ion battery and a manufacturing method thereof, which reduce the electrical resistivity of the positive electrode tab and the negative electrode tab, thereby reducing the heating of the positive electrode tab and the negative electrode tab during high current charging and discharging.

In an aspect of the present invention, a lithium ion battery is provided. The lithium ion battery includes: a positive active material; a negative active material disposed opposite to the positive active material; a separator and an electrolyte disposed between the positive active material and the negative active material; a positive electrode tab in electrical contact with the positive active material and a negative electrode tab in electrical contact with the negative active material; and a case encapsulating the positive active material, the negative active material, the separator and the electrolyte; wherein a surface of the positive electrode tab and/or a surface of the negative electrode tab are provided with a plurality of recess structures.

Optionally, in some embodiments, the positive electrode tab comprises an aluminum strip and a silver layer disposed on a surface of the aluminum strip; the negative electrode tab comprises a copper strip and a silver layer disposed on a surface of the copper strip; the plurality of recess structures are disposed on the silver layer of the positive electrode tab and/or the silver layer of the negative electrode tab.

Optionally, in some embodiments, a depth of the recess structure is less than or equal to 10 micrometers; and a width of the recess structure is less than or equal to 50 micrometers.

Optionally, in some embodiments, a thickness of the positive electrode tab and a thickness of the negative electrode tab are in a range of 50-500 micrometers.

Optionally, in some embodiments, the positive active material includes at least one of lithium manganite (LiMn₂O₄), lithium cobaltate (LiCoO₂), lithium nickel cobalt manganese oxide (LiNiMnCoO₂), and lithium iron phosphate (LiFePO₄).

Optionally, in some embodiments, the negative active material includes at least one of graphite, a mixture of graphite and silicon, titanium dioxide (TiO₂), and lithium titanate (Li₄Ti₅O₁₂).

### BRIEF DESCRIPTION OF THE DRAWINGS

In order to more clearly illustrate the technical solutions in embodiments of the invention or in the prior art, the appended drawings needed to be used in the description of the embodiments or the prior art will be introduced briefly in the following. Obviously, the drawings in the following description are only some embodiments of the invention, and for those of ordinary skills in the art, other drawings may be obtained according to these drawings under the premise of not paying out creative work.

FIG. 1 is a schematic diagram of a lithium ion battery according to an embodiment of the present invention; and

FIG. 2 is a cross-sectional view taken along line A-A′ of FIG. 1.

### DETAILED DESCRIPTION OF THE INVENTION

In the following, the technical solutions in embodiments of the invention will be described clearly and completely in connection with the drawings in the embodiments of the invention. Obviously, the described embodiments are only part of the embodiments of the invention, and not all of the embodiments. Based on the embodiments in the invention, all other embodiments obtained by those of ordinary skills in the art under the premise of not paying out creative work pertain to the protection scope of the invention.

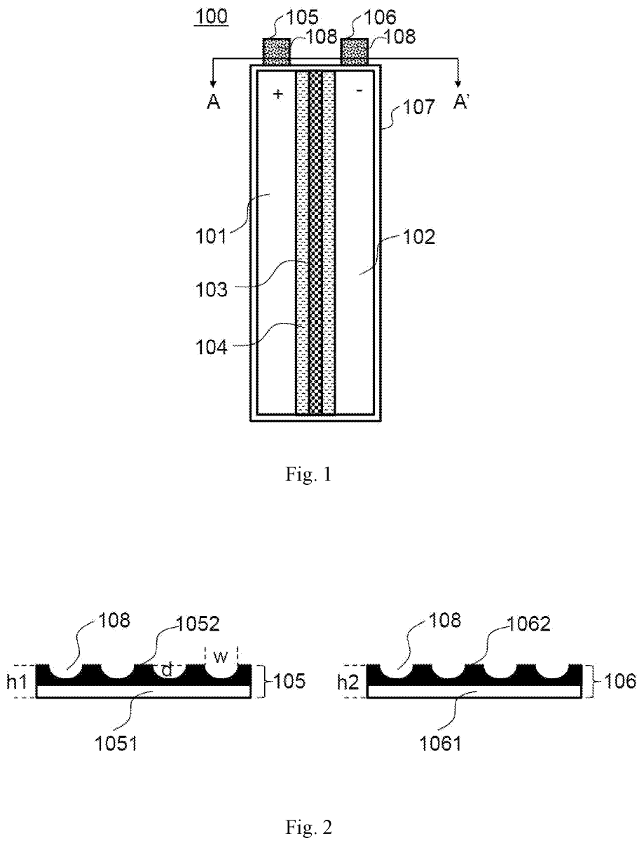

In an aspect of the present invention, a lithium ion battery is provided. Referring to FIG. 1 and FIG. 2, the lithium ion battery 100 includes: a positive active material 101; a negative active material 102 disposed opposite to the positive active material 101; a separator 103 and an electrolyte 104 disposed between the positive active material 101 and the negative active material 102; a positive electrode tab 105 in electrical contact with the positive active material 101 and a negative electrode tab 106 in electrical contact with the negative active material 102; and a case 107 encapsulating the positive active material 101, the negative active material 102, the separator 103 and the electrolyte 104; wherein a surface of the positive electrode tab 105 and/or a surface of the negative electrode tab 106 are provided with a plurality of recess structures 108.

In the embodiments of the invention, the surface of the positive electrode tab and/or the surface of the negative electrode tab are provided with a plurality of recess structures. With the plurality of recess structures, the surface area of the positive/negative electrode tabs is increased, thereby reducing the contact resistance between the positive/negative electrode tabs and the external wires, and reducing the heat generated by the lithium ion battery during high current charging and discharging.

A roll with a plurality of protruding structures may be used in an imprinting process for the positive/negative electrode tab, so as to obtain the plurality of recess structures. Alternatively, an etching process may be performed on the positive/negative electrode tab to obtain the plurality of recess structures.

Optionally, as shown in FIG. 2, in some embodiments, the positive electrode tab 105 comprises an aluminum strip 1051 and a silver layer 1052 disposed on a surface of the aluminum strip 1051; the negative electrode tab 106 comprises a copper strip 1061 and a silver layer 1062 disposed on a surface of the copper strip 1601; the plurality of recess structures 108 are disposed on the silver layer 1052 of the positive electrode tab and/or the silver layer 1062 of the negative electrode tab.

Optionally, as shown in FIG. 2, in some embodiments, a depth d of the recess structure 108 is less than or equal to 10 micrometers; and a width w of the recess structure 108 is less than or equal to 50 micrometers.

Optionally, as shown in FIG. 2, in some embodiments, a thickness h1 of the positive electrode tab 105 and a thickness h2 of the negative electrode tab 106 are in a range of 50-500 micrometers.

Optionally, in some embodiments, the positive active material includes at least one of lithium manganite (LiMn₂O₄), lithium cobaltate (LiCoO₂), lithium nickel cobalt manganese oxide (LiNiMnCoO₂), and lithium iron phosphate (LiFePO₄).

Optionally, in some embodiments, the negative active material includes at least one of graphite, a mixture of graphite and silicon, titanium dioxide (TiO₂), and lithium titanate (Li₄Ti₅O₁₂).

According to the lithium ion battery of the present invention, with the plurality of recess structures, the surface area of the positive/negative electrode tabs is increased, thereby reducing the contact resistance between the positive/negative electrode tabs and the external wires, and reducing the heat generated by the lithium ion battery during high current charging and discharging.

The indefinite articles “a” and “an” as used herein in the specification and in the claims, unless clearly indicated to the contrary, should be understood to mean “at least one”.

The phrase “and/or” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B”, or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising”, “including”, “carrying”, “having”, “containing”, “involving”, “holding”, “composed of” and the like are to be understood to be open-ended, i.e., to mean including but not limited to. Only the transitional phrases “consisting of” and “consisting essentially of” shall be closed or semi-closed transitional phrases, respectively.

The above embodiments are only used for explanations rather than limitations to the present invention, the ordinary skilled person in the related technical field, in the case of not departing from the spirit and scope of the present invention, may also make various modifications and variations, therefore, all the equivalent solutions also belong to the scope of the present invention, the patent protection scope of the present invention should be defined by the claims.

1. A lithium ion battery, comprising:
a positive active material;
a negative active material disposed opposite to the positive active material;
a separator and an electrolyte disposed between the positive active material and the negative active material;
a positive electrode tab in electrical contact with the positive active material and a negative electrode tab in electrical contact with the negative active material; and
a case encapsulating the positive active material, the negative active material, the separator and the electrolyte;
wherein a surface of the positive electrode tab and/or a surface of the negative electrode tab are provided with a plurality of recess structures.

2. The lithium ion battery according to claim 1, wherein the positive electrode tab comprises an aluminum strip and a silver layer disposed on a surface of the aluminum strip; the negative electrode tab comprises a copper strip and a silver layer disposed on a surface of the copper strip; the plurality of recess structures are disposed on the silver layer of the positive electrode tab and/or the silver layer of the negative electrode tab.

3. The lithium ion battery according to claim 1, wherein a depth of the recess structure is less than or equal to 10 micrometers; and a width of the recess structure is less than or equal to 50 micrometers.

4. The lithium ion battery according to claim 3, wherein a thickness of the positive electrode tab and a thickness of the negative electrode tab are in a range of 50-500 micrometers.

5. The lithium ion battery according to claim 1, wherein the positive active material comprises at least one of lithium manganate, lithium cobaltate, lithium nickel cobalt manganese oxide, and lithium iron phosphate.

6. The lithium ion battery according to claim 1, wherein the negative active material comprises at least one of graphite, a mixture of graphite and silicon, titanium dioxide, and lithium titanate.
